(19) United States
(12) Patent Application Publication
(10) Pub. No.: US 2009/0321454 A1
(43) Pub. Date: Dec. 31, 2009

(54) Paper Baking Utensil

(76) Inventor: Feng-Hsin Huang, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/490,428

(22) Filed: Jun. 24, 2009

(30) Foreign Application Priority Data
Jun. 26, 2008 (TW) 097211348

(51) Int. Cl. A47J 37/01

(52) U.S. Cl. 220/573.1

(57) ABSTRACT

A paper baking utensil includes a foldable body and a retaining member mounted on and enclosed around the foldable body. The foldable body is a sheet plate made of paper and is provided with a plurality of folding lines. The foldable body has a determined profile by bending and folding the folding lines of the foldable body. The retaining member is a hollow frame and has a determined profile matching that of the foldable body to fix and limit the foldable body so as to prevent the foldable body from being deformed or distorted.

### BACKGROUND OF THE INVENTION

1. Field of the Invention

The present invention relates to a baking utensil and, more particularly, to a paper baking utensil for placing and baking foods.

2. Description of the Related Art

A conventional baking utensil comprises a support frame and a tray mounted in the support frame to place a food, such as a cake. The support frame is made of metallic material. The support frame has an upper portion having a periphery provided with a support flange. The support frame has a hollow lower portion. The tray is made of silicone. The tray has an upper portion having a periphery provided with a bent lip abutting the support flange of the support frame and a lower portion protruding from the hollow lower portion of the support frame. Thus, when the baking process is accomplished, the lower portion of the tray is pushed upward to detach the lip of the tray from the support flange of the support frame and to detach the tray from the support frame. However, the support frame is made of metallic material having a greater heating conducting effect so that a user is easily burned or scalded by the support frame at a higher temperature, thereby causing danger to the user when touching the support frame. In addition, the support frame made of metallic material has a heavier weight and a higher cost of fabrication.

### BRIEF SUMMARY OF THE INVENTION

In accordance with the present invention, there is provided a paper baking utensil, comprising a foldable body and a retaining member mounted on and enclosed around the foldable body. The foldable body is a sheet plate made of paper and is provided with a plurality of folding lines. The foldable body has a determined profile by bending and folding the folding lines of the foldable body. The retaining member is a hollow frame and has a determined profile matching that of the foldable body to fix and limit the foldable body so as to prevent the foldable body from being deformed or distorted.

The primary objective of the present invention is to provide a paper baking utensil having a lower cost of fabrication.

Another objective of the present invention is to provide a paper baking utensil having multiple different shapes.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a paper baking utensil in accordance with the preferred embodiment of the present invention.

FIG. 2 is an exploded perspective view of the paper baking utensil as shown in FIG. 1.

FIG. 3 is a front cross-sectional view of the paper baking utensil as shown in FIG. 1.

FIG. 4 is a top view of a foldable body of the paper baking utensil as shown in FIG. 1.

FIG. 5 is a cross-sectional view showing a coating layer of the paper baking utensil as shown in FIG. 1.

FIG. 6 is an exploded perspective view of a paper baking utensil in accordance with another preferred embodiment of the present invention.

FIG. 7 is a perspective view of a paper baking utensil in accordance with another preferred embodiment of the present invention.

FIG. 8 is an exploded perspective view of the paper baking utensil as shown in FIG. 7.

FIG. 9 is a top view of a foldable body of the paper baking utensil as shown in FIG. 7.

FIG. 10 is an exploded perspective view of a paper baking utensil in accordance with another preferred embodiment of the present invention.

### DETAILED DESCRIPTION OF THE INVENTION

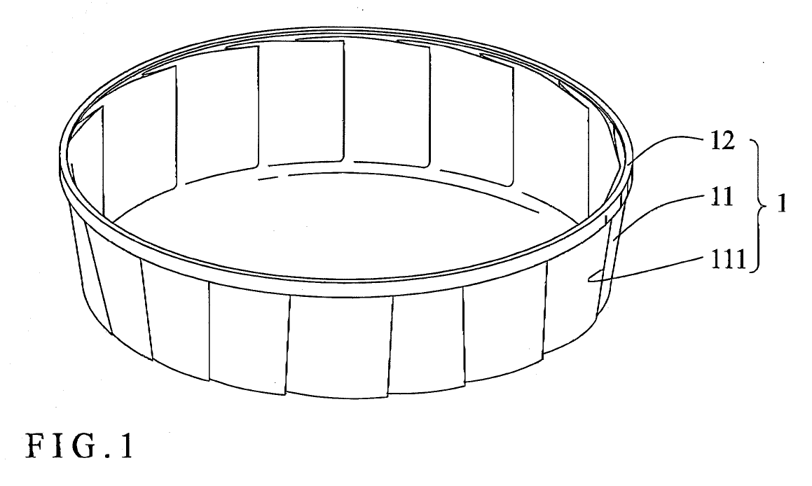

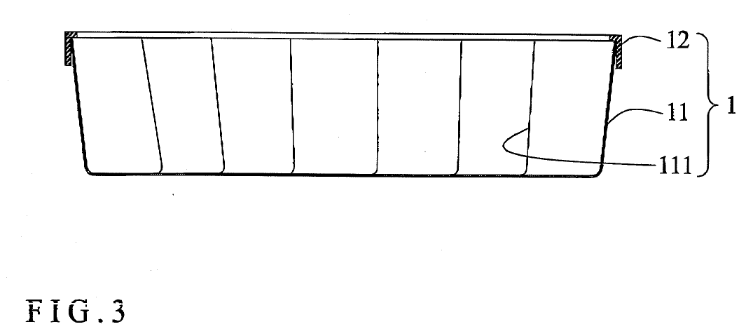

Referring to the drawings and initially to FIGS. 1-4, a paper baking utensil 1 in accordance with the preferred embodiment of the present invention comprises a foldable body 11 and a retaining member 12 mounted on and enclosed around the foldable body 11.

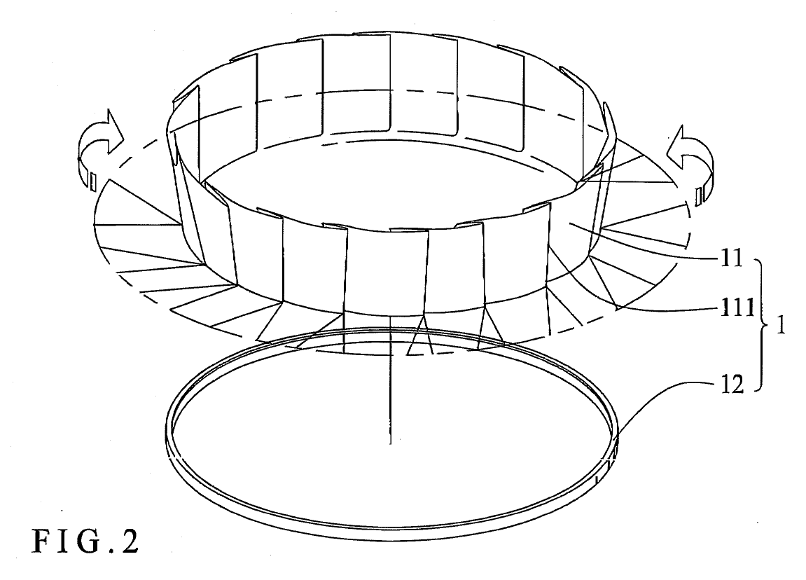

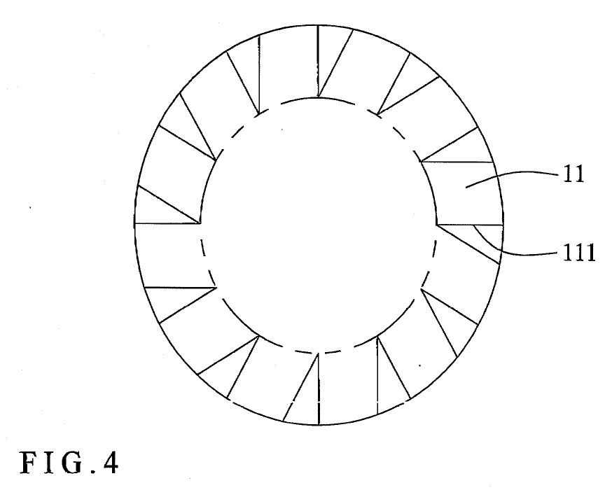

The foldable body 11 is a sheet plate made of paper. The foldable body 11 is expanded to have a flat shape as shown in FIG. 4 before the foldable body 11 is folded. The foldable body 11 is provided with a plurality of folding lines 111 so that the foldable body 11 has a determined profile by bending and folding the folding lines 111 of the foldable body 11 as shown in FIG. 2. Preferably, the foldable body 11 has an annular shape.

The retaining member 12 is removably mounted on the foldable body 11. The retaining member 12 is a hollow frame and has a determined profile matching that of the foldable body 11 to fix and limit the foldable body 11 so as to prevent the foldable body 11 from being deformed or distorted. Preferably, the retaining member 12 has an annular shape. The retaining member 12 is made of a metallic material or a plastic material (when use in a microwave oven), such as polypropylene (PP) to endure a higher temperature. The retaining member 12 has a substantially inverted L-shaped cross-sectional profile. The retaining member 12 is mounted on a top of the foldable body 11 so as to support the foldable body 11 exactly and stably.

In practice, a food, such as a cake and the like, to be baked is placed into the foldable body 11. At this time, the foldable body 11 is limited by the retaining member 12 so as to fix the food. Then, the foldable body 11 together with the food is placed into an oven so that the food can be baked in the oven. When the baking process is finished, the foldable body 11 together with the food is removed from the oven.

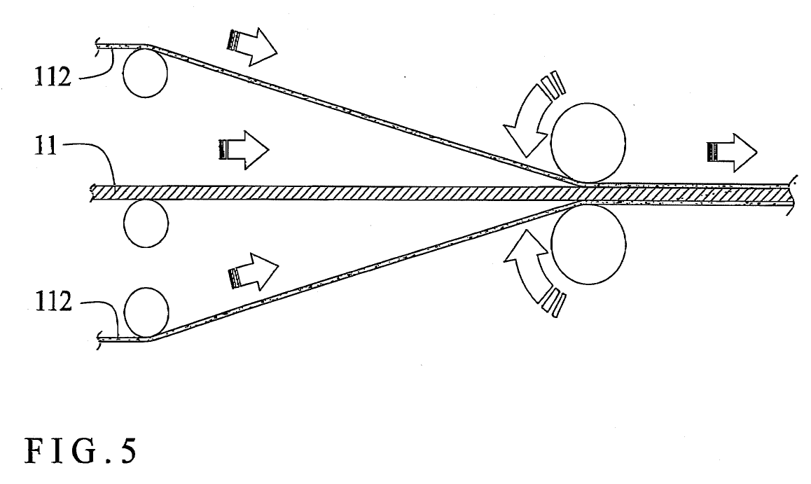

As shown in FIG. 5, the paper baking utensil further comprises a coating layer 112 mounted on a surface of the foldable body 11 by coating, rolling or spraying so that the surface of the foldable body 11 is non-sticky. Preferably, the coating layer 112 is made of silicone or a non-stick coating.

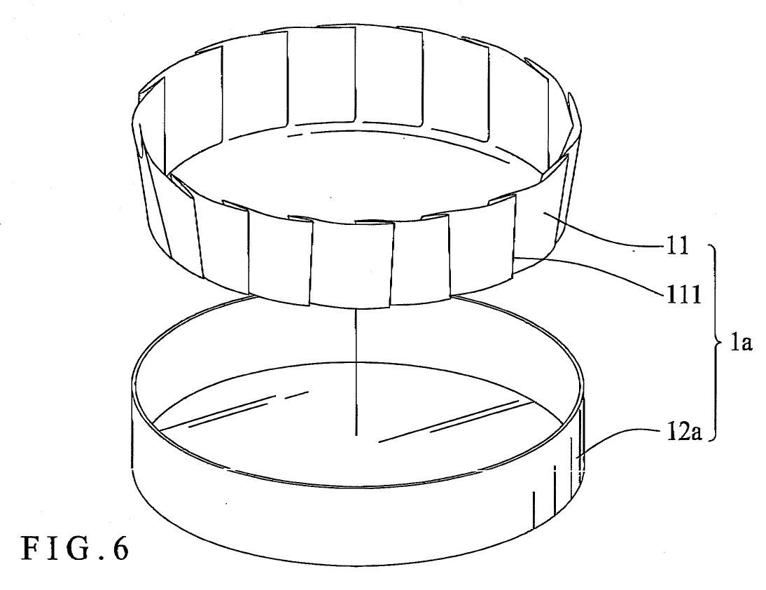

As shown in FIG. 6, the retaining member 12a of the paper baking utensil 1a has a substantially pan shape and has a substantially U-shaped cross-sectional profile. The retaining member 12a encompasses a periphery of the foldable body 11 so that the foldable body 11 is surrounded by and fully hidden in the retaining member 12a.

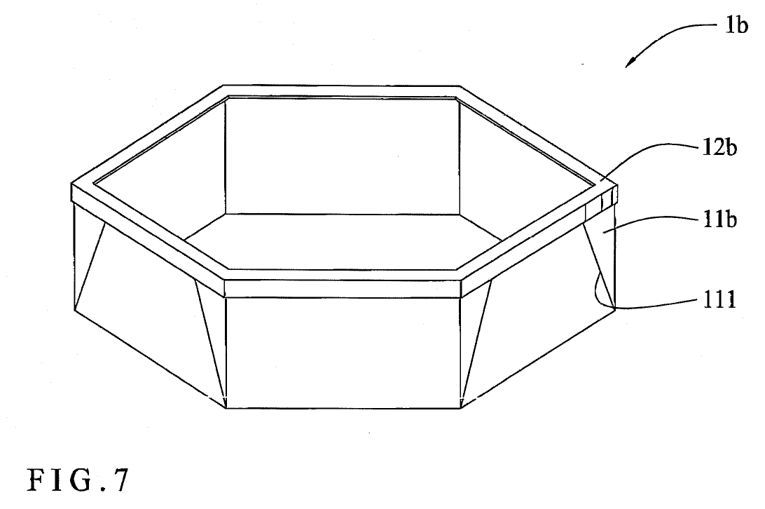

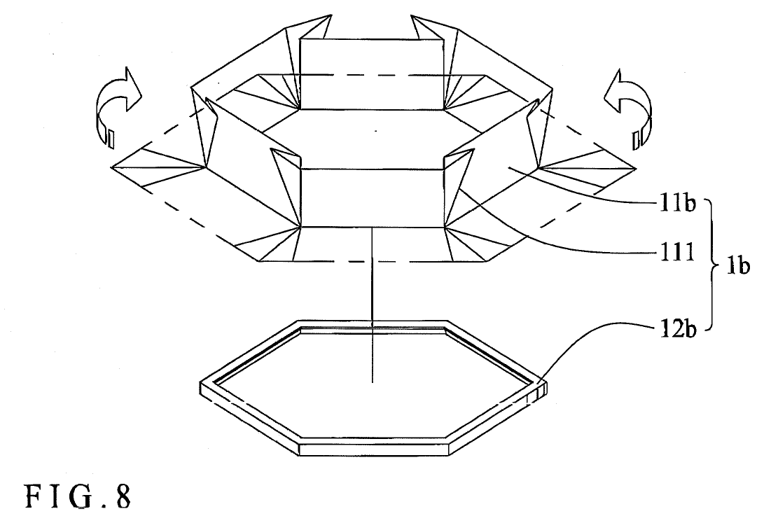

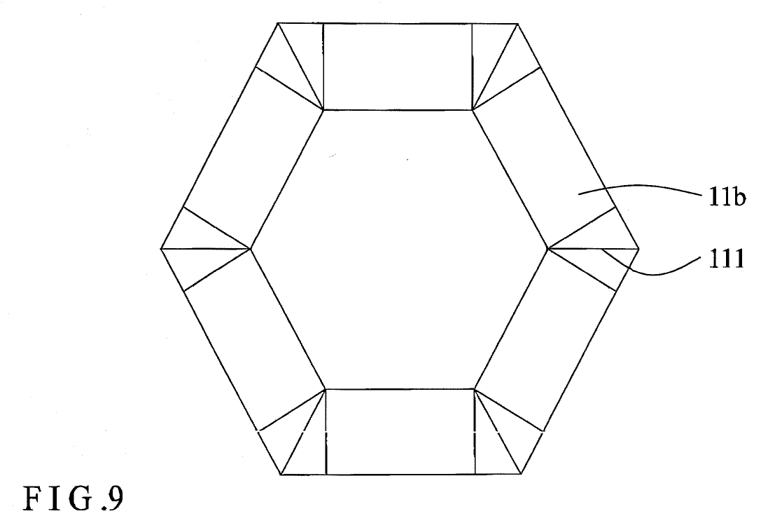

Referring to FIGS. 7-9, the foldable body 11b of the paper baking utensil 1b has a substantially hexagonal profile, and the retaining member 12b also has a substantially hexagonal profile matching that of the foldable body 11b.

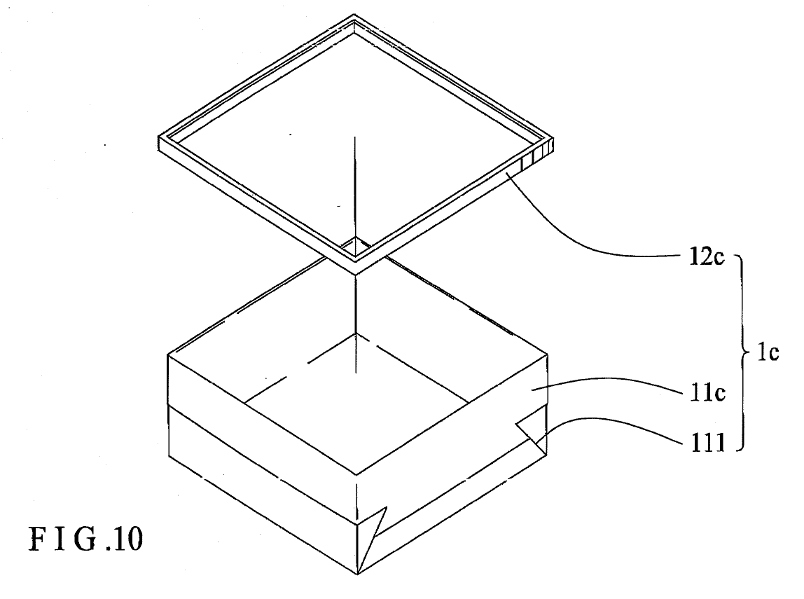

Referring to FIG. 10, the foldable body 11c of the paper baking utensil 1c has a substantially square profile, and the retaining member 12c also has a substantially square profile matching that of the foldable body 11c.

Accordingly, the foldable body 11 bent and folded to have a determined profile by bending and folding the folding lines 111 of the foldable body 11 so that the foldable body 11 is formed easily and quickly, thereby facilitating fabrication of the paper baking utensil. In addition, the foldable body 11 is made of paper having a lower price, thereby decreasing the costs of fabrication. Further, the foldable body 11 is formed to have different shapes so that the food placed in the foldable body 11 is baked to have different shapes according to a user's practical requirement, thereby enhancing the aesthetic quality of the food and enhancing the versatility of the paper baking utensil. Further, the foldable body 11 is expanded to have a flat shape after the baking process so that the foldable body 11 occupies a smaller space, thereby greatly facilitating packaging, storage and transportation of the paper baking utensil. Further, the surface of the foldable body 11 is non-sticky by provision of the coating layer 112 so that the foldable body 11 can be reused and recycled so as to protect the environmental. Further, the foldable body 11 is made of paper to prevent the user from being burned or scalded when touching the foldable body 11 that is removed from the oven.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A paper baking utensil, comprising:
a foldable body;
a retaining member mounted on and enclosed around the foldable body;
wherein:
the foldable body is a sheet plate made of paper;
the foldable body is provided with a plurality of folding lines;
the foldable body has a determined profile by bending and folding the folding lines of the foldable body;
the retaining member is a hollow frame;
the retaining member has a determined profile matching that of the foldable body to fix and limit the foldable body so as to prevent the foldable body from being deformed or distorted.

2. The paper baking utensil of claim 1, further comprising:
a coating layer mounted on a surface of the foldable body by coating, rolling or spraying.

3. The paper baking utensil of claim 2, wherein the coating layer is made of silicone or a non-stick coating.

4. The paper baking utensil of claim 1, wherein the retaining member has a substantially inverted L-shaped cross-sectional profile.

5. The paper baking utensil of claim 4, wherein the retaining member is mounted on a top of the foldable body so as to support the foldable body.

6. The paper baking utensil of claim 1, wherein the retaining member has a substantially pan shape;

7. The paper baking utensil of claim 6, wherein the retaining member has a substantially U-shaped cross-sectional profile.

8. The paper baking utensil of claim 1, wherein the retaining member is made of a metallic material or a plastic material of polypropylene (PP) to endure a higher temperature.

9. The paper baking utensil of claim 1, wherein
the foldable body has an annular shape;
the retaining member has an annular shape.

10. The paper baking utensil of claim 7, wherein
the retaining member encompasses a periphery of the foldable body;
the foldable body is surrounded by and fully hidden in the retaining member.

11. The paper baking utensil of claim 1, wherein
the foldable body has a substantially hexagonal profile;
the retaining member has a substantially hexagonal profile matching that of the foldable body.

12. The paper baking utensil of claim 1, wherein
the foldable body of the paper baking utensil has a substantially square profile;
the retaining member has a substantially square profile matching that of the foldable body.

13. The paper baking utensil of claim 1, wherein the foldable body is expanded to have a flat shape before the foldable body is folded.

14. The paper baking utensil of claim 1, wherein the retaining member is removably mounted on the foldable body.
